(19) United States
(12) Patent Application Publication
(10) Pub. No.: US 2006/0085492 A1
(43) Pub. Date: Apr. 20, 2006

(54) System and method for modifying process navigation

(76) Inventors: Arun Kumar Singh, Houston, TX (US); Gary Singh Grewal, Houston, TX (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/965,168

(22) Filed: Oct. 14, 2004

(51) Int. Cl. G06F 17/30; G06F 17/00; G06F 15/16; G06F 17/24; G06F 3/00

(52) U.S. Cl. 707/203; 715/854; 715/501.1; 715/731; 709/217; 707/10

(57) ABSTRACT

This invention pertains to simplifying the modification of a process flow implemented by computer software. That is, an order of presentation of sets of data, which may be web pages, is defined in one repository so that any changes that need to be made to the order may be made in the one location, instead of having to make the change in multiple locations. The one repository, therefore, acts as a navigation repository that stores, in one location, the navigation information needed to advance from one set of data to another.

### FIELD OF THE INVENTION

This invention relates to modifying process navigation. In particular, this invention pertains to simplifying the modification of a process flow implemented by computer software.

### BACKGROUND OF THE INVENTION

Web sites, which are a collection of web pages, have become a significant, if not vital, way for businesses to advertise and otherwise communicate and interact with the public. Because of their importance, businesses often invest enormous amounts of money in developing web sites with detailed and rich content. A user from the public often views such content by navigating through a sequence of web pages on the web site, typically by selecting a “link” on one web page that advances the user to another web page. On some web pages, the user may be automatically advanced to another web page, such as when one web page has been removed, and the user is forwarded to a new web page that has taken its place.

Conventionally, these “links,” automatic advancing, and other web site navigation techniques are “hard-coded” into the web pages that contain them. For example, a conventional link defined in HTML may appear as, “<LINK HREF=“nextpage.html”>”. In this example, if the link is selected, it will advance the user to the “nextpage.html” web page. If an administrator of the web site wants to change all links to “nextpage.html” to “differentpage.html”, then the administrator must manually change every web page in which such a link appears. The same manual editing is also required for the other conventional navigation techniques.

Because web sites often include hundreds, if not thousands of web pages, even changing a single web page in a sequence of web pages from, for example, “nextpage.html” to “differentpage.html”, can be an enormous undertaking that is time consuming, expensive, and error-prone. Further, because web sites are often continually updated with new information and new web pages, the burdensome task of manually correcting each web page to refer to the new information and/or web pages can become perpetual.

Accordingly, a need in the art exists for a simple and efficient way to modify a sequence of web pages in a web site.

### SUMMARY OF THE INVENTION

These problems are addressed and a technical solution achieved in the art by a system and method for modifying process navigation. In one embodiment of the invention, the process is one or more sequences of web pages that may be displayed to a user of a web site. According to one aspect of the invention, an order of presentation of a set of data, which may be a web page, is defined in a repository so that any changes that need to be made to the order may be made in the one logical location, instead of having to make the change in multiple locations. The repository, therefore, acts as a navigation repository that stores, in one logical location, the navigation information needed to advance from one set of data to another. In contrast, the conventional techniques store such navigation information across all sets of data, or web pages, for example. Consequently, the complexity associated with changes to the order of presentation of the sets of data is greatly reduced. The order of presentation of the sets of data is referred to herein as the “navigation flow.”

According to one embodiment of the invention, the repository is one or more XML files that define and store the navigation flow. For each set of data, the XML file(s) specify which set of data precedes the current set of data in the navigation flow, which set of data follows the current set of data in the navigation flow, and whether the navigation flow should automatically advance to the next set of data.

According to one embodiment of the invention, employees of a company define the navigation flow, which may be converted into an activity diagram that is used to generate the navigation flow stored in the repository.

### BRIEF DESCRIPTION OF THE DRAWINGS

A more complete understanding of this invention may be obtained from a consideration of this specification taken in conjunction with the drawings, in which:

FIG. 1 illustrates a development cycle according to an embodiment of the present invention;

FIG. 2 illustrates a computer system according to an embodiment of the invention;

FIG. 3 illustrates on organization of a plurality of sets of data according to an embodiment of the invention;

FIG. 4 illustrates a sample repository according to an embodiment of the invention;

FIG. 5 illustrates an initial interaction between exemplary processes according to an embodiment of the invention;

FIG. 6 illustrates an interaction between the processes of FIG. 5 subsequent to the initial interaction according to an embodiment of the invention;

FIG. 7 illustrates a class diagram of the processes described in FIGS. 5 and 6 according to an embodiment of the invention.

It is to be understood that these figures are for purposes of illustrating the concepts of the invention and are not to scale.

### DETAILED DESCRIPTION OF THE EXEMPLARY EMBODIMENT(S) OF THE INVENTION

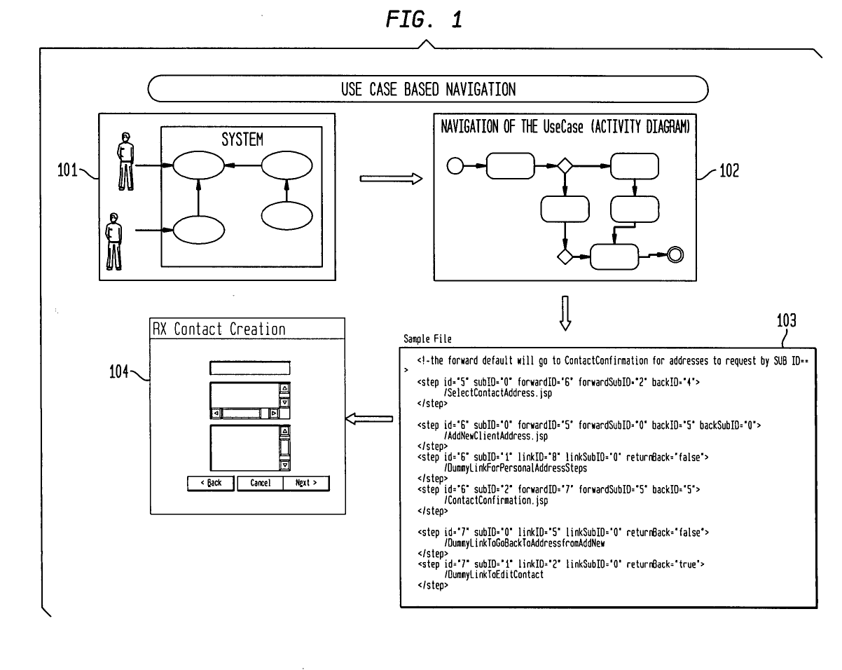

A flow chart illustrating a development cycle according to an embodiment of the invention will be described with reference to FIG. 1. In FIG. 1, at step 101, business analysts or other employees of a business define a set of requirements that will meet a business need. The requirements may, for example, define what the business needs or objectives are for a proposed web site for the business. In other words, the employees decide what the business needs to display on its web pages and provide an overall view of how the information is to be broken down for display purposes on the web pages. Although the invention is often described in the context of web sites and web pages, one skilled in the art will appreciate that the invention is not so limited and includes within its scope any arrangement in which sets of data are presented in an order and changes need to be made to such ordering.

Next at step 102, the requirements are documented as a process flow, which may be an activity diagram, known in the art. In other words, a process flow may be created that illustrates all possible sequences in which sets of data may be displayed, i.e., the navigation flow. Examples of sets of data include, but are not limited to, web pages, stand alone applications and Wizard based applications such as dialog boxes used when configuring an application such as Microsoft Outlook. At step 103, a navigation flow is generated automatically, manually, or a combination of both, from the process flow created at step 102 and is stored in a navigation repository. The navigation repository describes and stores the navigation flow, and may, for example, be one or more XML files. Although the navigation repository is described as an XML file in one embodiment of the invention, one skilled in the art will appreciate that any manner of storing and representing a process flow may be used.

The repository serves as a navigational intelligence tool for determining which set of data should be currently presented. In the case of a web site, as shown at step 204, the repository is accessed to determine which web page should be presented to a user based upon the user's current web page and the action the user has taken.

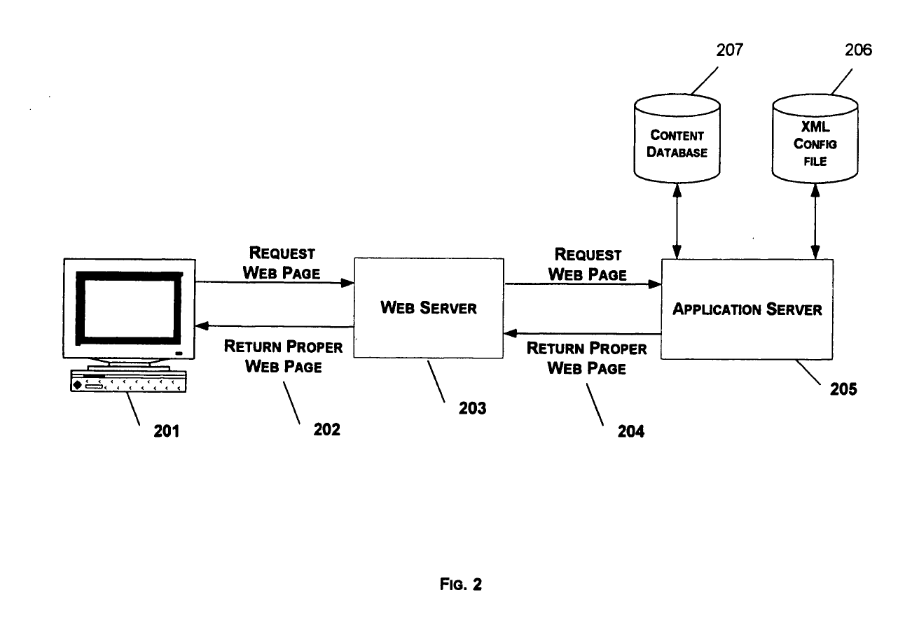

A computer system according to an exemplary embodiment of the present invention will now be described with reference to FIG. 2. In FIG. 2, a client computer 201, such as a workstation, is in communication via communication link 202 with web server 203. Web server 203 is in communication with application server 205 via communication link 204. Application server 205 is in communication with the repository 206, which may be one or more XML configuration files, and content database 207.

Client computer 201 can be a desktop computer, or any other type of computer such as a laptop, hand-held device, or any device capable of processing data. In the exemplary embodiment, client computer 201 belongs to a user browsing through a company's website. Although shown separate from application server 205, one skilled in the art will appreciate that the XML configuration file 206 and the content database 207 may be located within application server 205 on a computer-readable memory, or within another computer communicatively connected to application server 205. In addition, one skilled in the art will appreciate that the XML configuration file 206 or the content database 207 may be implemented as a single database or a data storage system comprising multiple databases and/or data storage devices. Further, any method of communication known in the art between computers may be used between client computer 201, web server 203, application server 205, and any other computer containing XML configuration file 206 and content database 207. Communication links 202 and 204 need not be a hardwired network, and may be wireless, or a combination of both.

With reference to FIG. 2, a user working at client computer 201, sends a request to web server 203 for data, in this case requesting a particular web page, via communication link 202. Web server 203 then authenticates the user's request and passes it on to application server 205, if authenticated. User authentication may consist of verifying the user's rights to view certain web pages. After the application server 205 receives the request from the web server 203, the application server 205 determines what web page to send to the user by accessing the XML configuration file 206, which stores the navigation structure of the website's pages and links. Once the application server 205 determines which web page should be sent to the user in response to the request, application server 205 retrieves the appropriate web page and associated content from the content database 207. The application server 205 then sends the web page via communication link 204 to the web server 203, which returns the web page via communication link 202 to client computer 201.

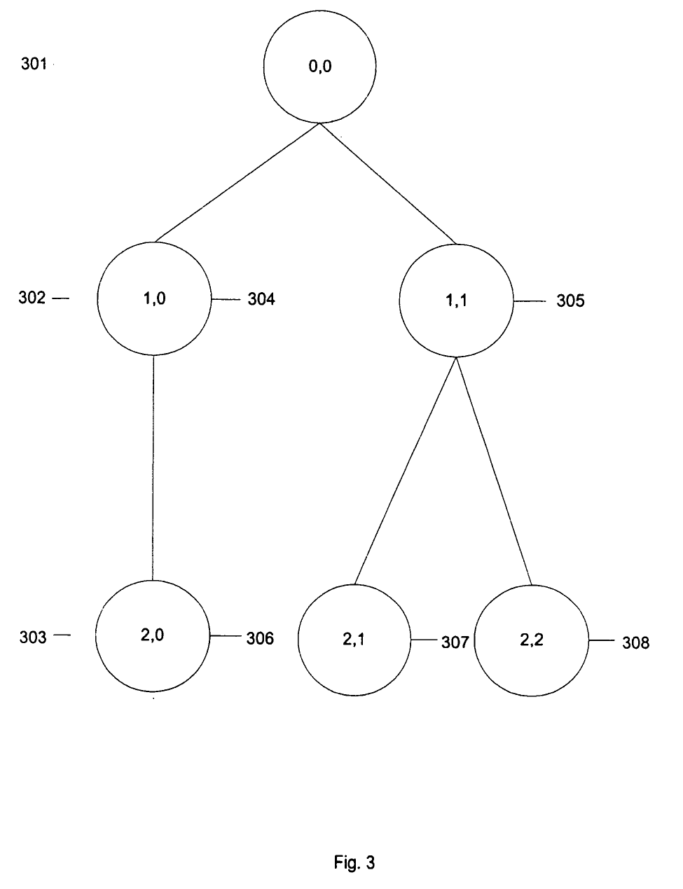

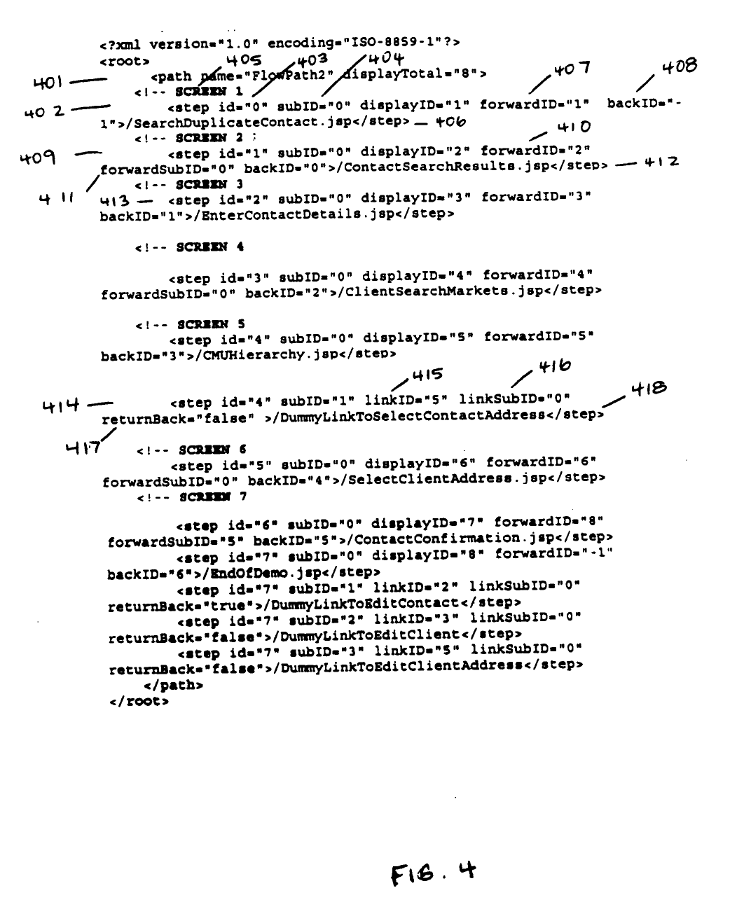

The content and structure of the XML configuration file 206 according to an embodiment of the invention will now be described in detail with reference to FIGS. 3 and 4. FIG. 3 illustrates a convention used by the exemplary configuration file 206 to identify web pages in a web site. In particular, the entire tree data structure shown in FIG. 3 illustrates a web site, and each node in the tree represents a web page in the web site. However, the tree data structure in FIG. 3 does not necessarily reflect how navigation occurs between nodes. Such navigation will be described below with reference to FIG. 4.

In FIG. 3, each node, or web page is identified by a “stepID” and a “subID”. The combination of the stepID and subID may be referred to as a “first information element.” A step ID identifies a level in the tree data structure, and a subID identifies a node in the level. As shown in the example of FIG. 3, there are three levels defined as stepID=0 301, stepID=1 302 and stepID=2 303, respectively. The second level defined by stepID=1 302 has two nodes, 304 and 305, which may represent a web page or other set of data. These two nodes are accordingly defined as stepID=1, subID=0 and stepID=1, subID=1, respectively. Level three, which is defined as stepID=2, has three nodes: 306-308. Node 306 is defined as stepID=2, subID=0, node 307 is defined by stepID=2, subID=1, and node 308 is defined as stepID=2, subID=2.

Turning now to FIG. 4, an example XML configuration file 206 will be described. For each web page in a web site, the XML file 206 identifies all navigation information associated with the web page and the location of any content associated with the web page in content database 207. The navigation information specifies which web page or web pages the user may go to next, and which web page or web pages the user may go back to. This information is stored in the XML file 206 using identifiers, such as “forwardID”, “forwardSubID”, “backID”, and “backSubID”.

The combination of “forwardID” and “forwardSubID”, collectively, a “second information element,” identifies the next web page that should be displayed to the user. For example, if forwardID=1 and forwardSubID=0, the web page identified by stepID=1, subID=0 will be the next web page displayed to the user. “backID” and “backSubID”, collectively, a “third information element,” work similarly. If backID=0 and backSubID=0, then the web page identified by stepID=0, subID=0 will be displayed to the user if they backtrack in the navigation process. A forwardID of negative one is determined to mean that there is no next web page to display to the user. Similarly, a backID of negative one means that there is no web page to go back to, which is common if the user is at a “home page,” known in the art. If no forwardSubID or backSubID are specified, they are presumed to be equal to zero.

Additional identifiers are “linkID” and “linkSubID”, which automatically advance the user to the web page at stepID=linkID, stepSubID=linkSubID. For instance, if the XML file 206 specifies LinkID=1, linkSubID=0, the user is automatically advanced to the web page at stepID=1, stepSubID=0 If no linkSubID is specified, it is presumed to be equal to zero.

An additional identifier is “display ID” which shows any information for a particular step at any screen. Thus, the same screen at different step levels can have different information displayed on it. The display ID allows the ability to debug when using identical or similar sets of data by indicating where in the navigation flow the user is. Because the display ID is used to identify the same or similar sets of data being presented at different times, it may also be used to customize messages or indicators depending on when the set of data is used.

Yet another identifier is “returnBack” which may have a value of true or false. This identifier may be used to override the “forwardID” of a set of data in order to direct the user back to a previous set of data. For example, if a user is viewing a first web page and selects a “Next” button on the web page, the “forwardID” may direct the user to a second web page. While on the second web page, the user may again select a “Next” button, where the “forward ID” of the second web page may direct the user to a third web page. Now, if the third web page has a “linkID” that directs the user back to the first web page, and a “returnBack” of True, the user may be automatically transferred to the first page. If the user now selects the “next” button on the first page, the user will be sent back to the third web page instead of going to the second web page as the “forwardID” instructs.

The example XML configuration file in FIG. 4 will now be described in detail. For clarity, FIG. 4 shows one sequence of web pages of a navigation flow, as identified by “<path name=“FlowPath2” displayTotal=“8”>” 401. However, one skilled in the art will appreciate that all possible paths or multiple paths may be defined in a single XML file. Navigation of the web site described with FIG. 4 begins at 402 with an initial web page, “Screen 1” 405 or home page, identified by step ID 403 and sub ID 404 equal to zero. In this example, the content to be displayed to the user when at the initial web page is “SearchDuplicateContact.jsp” 406, which would be located in the content database 207. Such reference to the location of the content may be referred to as a “fourth information element.” BackID=−1 408, a negative number, illustrates that the user cannot go backwards, because the user is at the initial web page. ForwardID=1 407 specifies that the user is to be advanced to the web page identified by stepID=1, SubID=0, as seen at line 409, when, for example, the user selects a “submit” button on the initial web page.

The content displayed to the user at the web page described at line 409, is “ContactSearchResults.jsp” 412. ForwardID=2 410 and ForwardsubID=0 411 indicates that when the user attempts to advance to the next web page, the user will be advanced to the web page identified by stepID=2, subID=0, as shown at 413. BackId=0 indicates that the user can go backwards on the web page identified by stepID=0, subID=0, which is the initial page described at 402.

The remaining web pages described in FIG. 3 are similarly structured. However, the web page identified by stepID=4, subID=1, at 414 includes a linkID=5 415 and a subLinkID=0 416. The linkID 415 and subLinkID 416, collectively, a “fifth information element,” indicate that the user is automatically advanced, i.e., is advanced without action on the user's part, to the web page identified by stepID=5, subID=0. Because the “web page” at line 414 automatically advances the user to another web page, it likely does not display content to the user and just serves as a forwarding function. Accordingly, in this example, no content is displayed to the user, and the web page is labeled as a dummy link to another web page, as shown at 418. ReturnBack=false 417 indicates that the user continues to the next page as requested and is not returned back to a prior page.

Although the example set forth in FIG. 4 primarily advances a user from screen 1 to screen 2 to screen 3 and so on for clarity, this need not be the case. The user can be advanced from any web page to any other web page. Further, although each web page is shown as having a single forward, back, or automatic link web page, web pages may be described in the XML file 206 as having multiple forward, back, or automatic link web pages. These multiple forward, back, or automatic links may be achieved in the XML configuration file by cloning the page at the XML level and not at the page level. That is, there is a virtual page cloning, not a physical cloning. In other words, the same page is given a unique ID—its StepID and SubID—so that every page is unique regardless of its contents. For example, page 2 can be located at stepID=2, subID=0 which may forward to Page 10 and (by setting ForwardID=10) page 2 can also be located at stepID=5, subID=0 which may forward to page 20 (by setting ForwardID=20). This is achieved by setting different values for the Forward ID.

Additionally, if a change to the navigation flow described in the XML file 206 is needed, all that need be changed is the appropriate “forwardID”, “forwardSubID”, “backID”, “backSubID”, “linkID”, and “linkSubID” identifiers in the XML file 206. For example if, in the example of FIG. 3, it is desired that the next web page after the initial web page at 402 be the webpage at stepID=2, subID=0, then only forwardID=1 407 needs to be changed to forwardID=2. In the conventional arrangements, the actual web page itself had to be retrieved and manually changed to reflect such a change.

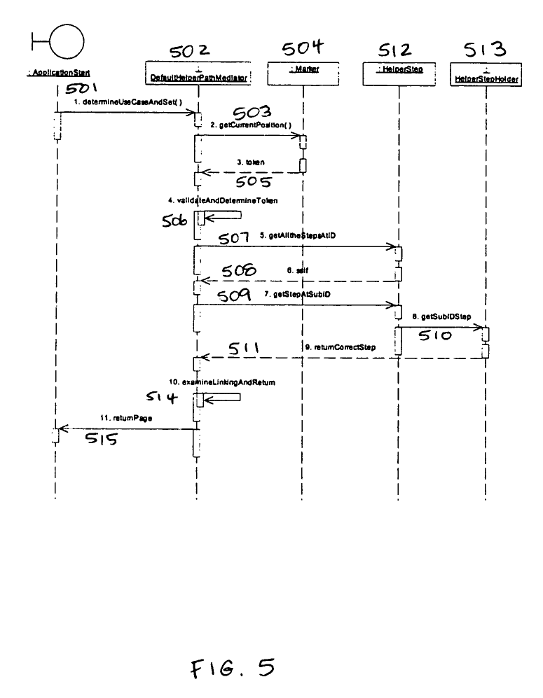

FIG. 5 represents a flow chart according to an exemplary embodiment of the present invention that describes the initial interactions between the functions or processes in exemplary Java software used to implement the present invention. Although described in the context of Java, one skilled in the art will appreciate that other programming languages may be used.

When a user is on a first web page and selects a ‘submit’ button or some other object to advance to a next web page, it is first determined at step 501 what web page the user is currently at and what the next page for the user should be. The system accesses a “DefaultHelperPathMediator” method at 502 which then passes the request to a Marker method 504 as seen by the request “getCurrentPosition( )” at step 503. Marker 504 returns a token 505 which tells the system what web page the user is currently on. At step 506, “validateAndDetermineToken”, the system confirms that the token 505 accurately describes the user's current web page. This step is important in ensuring that the user has not selected the “Back” button on their browser, thereby potentially misleading the marker method 504 as to what web page the user is currently viewing. At steps 507 through 511, based upon the current web page that the user is viewing, the HelperStep method 512 and HelperStepHolder method 513 respectively return to the DefaultHelperPathMediator method 502 the correct stepID and subID, respectively, of the next web page to be displayed to the user. The steps 507-511 utilize the “forwardID” and “forwardSubID” identifiers or the “backID” and “backSubID” identifiers in the XML file 206, to return such information. If no forwardID or forwardSubID identifiers are specified for the current web page, then the DefaultHelperPathMediator method 502 checks to see if the current web page is supposed to jump to another page at the “examineLinkingandReturn” step 514. The DefaultHelperPathMediator method 502 performs this task by checking for a linkID and/or linkSubID identifier in the XML file 206 for the current page. At step 515, the next page is compiled and returned to the web server 203.

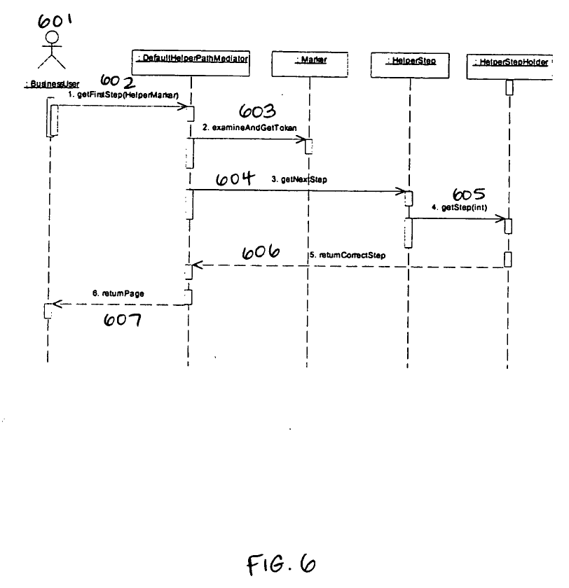

After the process of FIG. 5 has been executed, the application server 205 now knows the user's current web page, as identified by the token 505. Thereafter, the process of FIG. 6 is executed each time the user is attempting to advance to a next page or retreat to a prior page. At step 601, the user enters a command to go to another page. At step 602, the system attempts to determine what page comes next by sending a “getFirstStep(HelperMarker)” request 602 to the “DefaultHelperPathMediator” method 502. DefaultHelperPathMediator 502 reviews the request and sends an “examineAndGetToken” request on to the Marker method 504 at step 603. This request retrieves the token 505, which identifies the user's current page. With the current web page identified, the DefaultHelperPathMediator method 502 requests the stepID and subID of the next page to be displayed to the user at 604. The HelperStep method 512 and HelperStepHolder method 513 work in tandem at step 605, to return such information at 606. At 607, the DefaultHelperPathMediator method 502 assembles the next web page to be displayed and returns it to the web server 203.

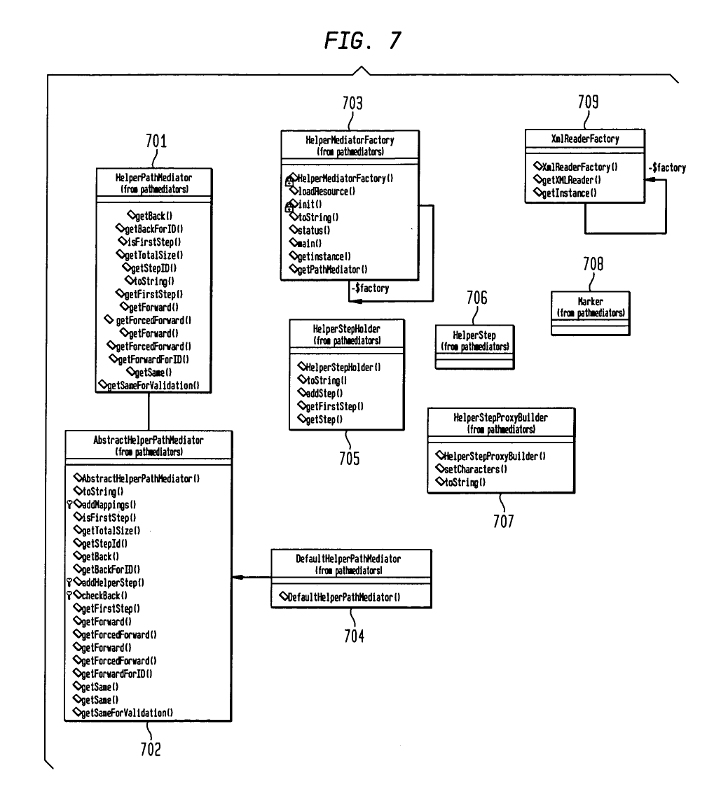

FIG. 7 is an example implementation of the processes described above in FIGS. 5 and 6 according to one embodiment of the invention. That is, it is a class diagram where the HelperPathMediator 701, Abstract HelperPathMediator 702, HelperMediatorFactor 703 and DefaultHelperPathMediator 704 represent exemplary classes used to implement the DefaultHelperPathMediator process, 502. HelperStepHolder 705 represents an exemplary class used to implement the HelperStepHolder 513. HelperStep 706 represents an exemplary class used to implement the HelperStep 512. HelperStepProxyBuilder 707 is an abstraction of HelperStep 512. In particular, HelperStep 706 is an object that stores the information pertaining to one set of data in the XML configuration file 206. For example, if a line in the XML configuration file 206 appears as, “<stepid=0” subID=0 forwardID=“1”>first set of data.jsp</step>”, all such data is stored in the object HelperStep706. The HelperStep object 706 is created with the assistance of HelperStepProxyBuilder 707 which extracts the values from the XML configuration file 206 needed to create HelperStep 706. The HelperStep object 706 is created during parsing of the configuration file 206. It may have all of its data fields fixed to avoid overwrites and may be directly accessible instead of being accessed by method calls to reduce response times.

Marker 708 represents an exemplary class used to implement the Marker method 502. Finally, XmlReaderFactory 709 is an abstraction to allow the XML Reader to parse out the XML file at the start of the application. XmlReaderFactory 709 is used to read the XML configuration file 206 and then to create the various HelperStep and holder objects needed to navigate.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

What is claimed is:

1. A computer-readable memory encoded with data, the memory comprising:
a first information element that identifies a set of data;
a second information element that identifies a next set of data;
a third information element that identifies a previous set of data; and
a fourth information element that identifies a location of contents of the set of data.

2. The memory of claim 1 further comprising a fifth information element that identifies an automatically retrieved set of data.

3. The memory of claim 1 wherein the set of data, the next set of data, and the previous set of data are each web pages.

4. The memory of claim 1 wherein the first, second, and third information elements comprise of at least one identifier.

5. The memory of claim 1 wherein the data complies with an XML format.

6. The memory of claim 1 wherein the fourth information element identifies a file comprising at least a portion of the set of data.

7. A computer implemented method for process navigation, the method comprising:
receiving a request for a requested set of data;
determining a current set of data;
retrieving the requested set of data based at least upon the current set of data and data in a computer-readable memory according to claim 1; and
transmitting the requested set of data.

8. The method of claim 7 wherein retrieving the requested set of data comprises:
locating the first information element, wherein the first information element identifies the current set of data;
locating either the second or third information element that identifies the requested set of data; and
using the located second or third information element to retrieve the requested set of data.

9. The method of claim 8 wherein the data in the computer-readable memory complies with an XML format.

10. A system for process navigation, the system comprising:
a computer-readable memory according to claim 1; and
a computer communicatively connected to the computer-readable memory, the computer programmed to perform actions comprising the method of claim 7.

11. A method for modifying an order of presentation of sets of data, the method comprising:
accessing a computer-readable memory according to claim 1; and
altering either the second or the third information element.

12. The method of claim 11 wherein the data in the computer-readable memory complies with an XML format.

13. A computer implemented method for process navigation, the method comprising:
receiving a request for a requested web page;
determining a current web page;
retrieving the requested web page based at least upon the current web page and data encoded in a computer-readable memory wherein the data complies with an XML format and the computer-readable memory comprises:
a first information element that identifies the current web page,
a second information element that identifies the requested web page, and
a third information element that identifies a location of contents of the requested web page; and
transmitting the requested web page.

14. A system for process navigation, the system comprising:
a computer-readable memory encoded with data wherein the data complies with an XML format and the computer-readable memory comprises:
a first information element that identifies a web page,
a second information element that identifies a next web page,
a third information element that identifies a previous web page,
a fourth information element that identifies a location of contents of the web page, and
a fifth information element that identifies an automatically retrieved web page;
a computer communicatively connected to the computer-readable memory, the computer programmed to perform actions comprising:
receiving a request for a requested web page;
determining a current web page;
retrieving the requested web page based at least upon the current web page and the data in the computer-readable memory; and
transmitting the requested web page.

15. A method for modifying an order of presentation of sets of data, the method comprising:
accessing a computer-readable memory encoded with data wherein the data complies with an XML format and the computer-readable memory comprises:
a first information element that identifies a web page,
a second information element that identifies a next web page,
a third information element that identifies a previous web page,
a fourth information element that identifies a location of contents of the web page, and
a fifth information element that identifies an automatically retrieved web page; and
altering either the second or third information element.
